(19) United States
(12) Patent Application Publication
(10) Pub. No.: US 2006/0286881 A1
(43) Pub. Date: Dec. 21, 2006

(54) Basic board member for electric facility

(75) Inventors: Chin Chun Chou, Taiping City (TW); I-Shou Tsai, Taiping City (TW); Weni Kuo, Taiping City (TW); Ya Chen Kuo, Taiping City (TW)

Correspondence Address: CHARLES E. BAXLEY, ESQ., 90 JOHN STREET, THIRD FLOOR, NEW YORK, NY, 10038, US

(73) Assignee: Yeu Ming Tai Chemical Industrial Co., Ltd.

(21) Appl. No.: 11/158,708

(22) Filed: Jun. 21, 2005

(51) Int. Cl. B32B 5/02

(52) U.S. Cl. 442/59

(57) ABSTRACT

A basic board member includes an inner fabric member, and a gelatinous emulsion disposed on the inner fabric member, to form a gel outer layer on the inner fabric member, after the gelatinous emulsion is cured, to facilitate a low dielectric characteristic to the basic board member. The inner fabric member includes one or more fabric layers made of polytetrafluoroethylene (PTFE) material, and preferably inclined relative to each other, having an included angle of about forty five (45) degrees. An outer fabric layer may further be attached onto the fabric layer. The gelatinous emulsion may include a polytetrafluoroethylene emulsion and a coupling agent mixed and stirred together.

### BACKGROUND OF THE INVENTION

1. Field of the Invention

The present invention relates to a basic board member for being used in various electric facilities, and more particularly to a basic board member for being used in various electric facilities and having a low dielectric constant or a low dielectric effect, for preventing or avoiding electric leakage, and for facilitating electric transmitting effect.

2. Description of the Prior Art

Typical electric facilities, such as computers, or other typical electric facilities comprise one or more basic board members, such as electric circuit boards, having electric circuits provided or printed thereon. Normally, the typical basic board members are made of glass fiber materials which includes excellent strengths, such as bending strengths, bearing strengths, breaking strengths, compressive strengths, etc.

However, the typical basic board members that are made of glass fiber materials include a dielectric constant of about 4.0, and may have an electric leakage problem, and may have a greatly lowered electric transmitting effect.

The present invention has arisen to mitigate and/or obviate the afore-described disadvantages of the conventional basic board members.

### SUMMARY OF THE INVENTION

The primary objective of the present invention is to provide a basic board member for being used in various electric facilities, and including a low dielectric constant or a low dielectric effect, for preventing or for avoiding electric leakage, and for facilitating electric transmitting effect.

In accordance with one aspect of the invention, there is provided a basic board member comprising an inner fabric member, and a gelatinous emulsion disposed on the inner fabric member, to form a gel outer layer on the inner fabric member, after the gelatinous emulsion is cured, to facilitate a low dielectric characteristic to the basic board member.

The inner fabric member includes at least one fabric layer made of polytetrafluoroethylene (PTFE) material. The inner fabric member includes at least one second fabric layer made of polytetrafluoroethylene (PTFE) material, and engaged onto the fabric layer.

The second fabric layer and the fabric layer are inclined relative to each other. The second fabric layer and the fabric layer include an included angle of forty five (45) degrees therebetween. An outer fabric layer may further be provided and attached onto an outer peripheral portion of the fabric layer of the inner fabric member.

The gelatinous emulsion includes a polytetrafluoroethylene emulsion and a coupling agent mixed and stirred together. The gelatinous emulsion further includes a nano ceramic powder mixed therein, and/or an SiO₂ powder mixed therein.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view of a basic board member in accordance with the present invention, taken along lines 1-1 of FIG. 2;

FIG. 2 is a cross sectional view of the basic board member, taken along lines 2-2 of FIG. 1;

FIG. 3 is a block diagram illustrating the operating or manufacturing processes of the basic board member;

FIG. 4 is a greatly enlarged partial perspective view of a gel layer of the basic board member; and

FIG. 5 is a cross sectional view similar to FIG. 2, illustrating the other arrangement of the basic board member.

### DETAILED DESCRIPTION OF THE PREFERRED EMBODIMENT

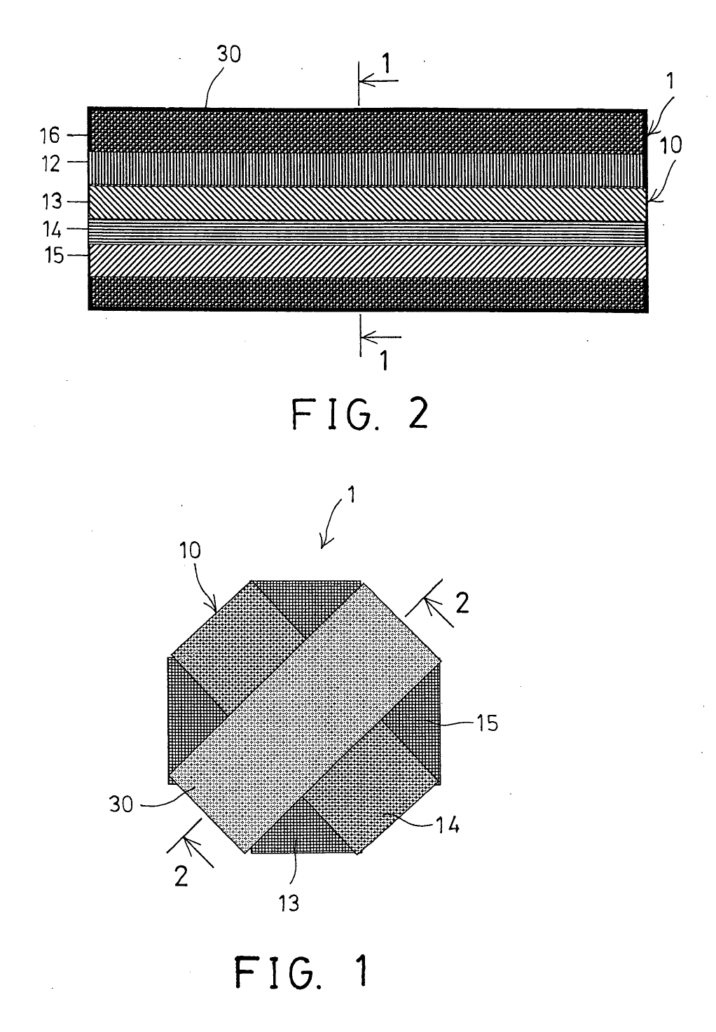

Referring to the drawings, and initially to FIGS. 1 and 2, a basic board member 1 in accordance with the present invention comprises a basic or body or core or inner fabric member 10 made of or formed by one or more fabric layers 12, 13, 14, 15 (FIGS. 1, 2) superposed with each other, and preferably arranged inclined to each other, best shown in FIG. 1, or formed by a single fabric layer 12, best shown in FIG. 5, in order to form a multilayered inner fabric member 10.

For example, it is preferable that the fabric layers 12, 13, 14, 15 are arranged inclined to each other for about forty five (45) degrees relative to each other, or have an included angle of about forty five (45) degrees therebetween. For example, the first fabric layer 12 is arranged inclined relative to a longitudinal direction or axis (not shown) of the basic board member 1 for about forty five (45) degrees, and the second fabric layer 13 is arranged inclined relative to the first fabric layer 12 for about forty five (45) degrees, such that the second fabric layer 13 will be substantially perpendicular to longitudinal direction or axis (not shown) of the basic board member 1.

Similarly, the third fabric layer 14 is arranged inclined relative to the second fabric layer 13 for about forty five (45) degrees, such that the third fabric layer 14 will be substantially perpendicular to the first fabric layer 12, and the fourth fabric layer 15 is arranged inclined relative to the third fabric layer 14 for about forty five (45) degrees, such that the fourth fabric layer 15 will be substantially perpendicular to the second fabric layer 13, best shown in FIG. 1, for allowing the inner fabric member 10 to include or to have excellent strengths.

The fabric layers 12, 13, 14, 15 are preferably made of polytetrafluoroethylene (PTFE) materials, which may first be made or formed into PTFE threads that may then be woven into the fabric layers 12, 13, 14, 15 by such as rapier loom machines, or other weaving machines, or the like. It is further preferable that another or outer fabric layer 16 may further be woven and provided and attached onto an outer peripheral portion of the fabric layers 12, 13, 14, 15 of the inner fabric member 10, best shown in FIG. 2.

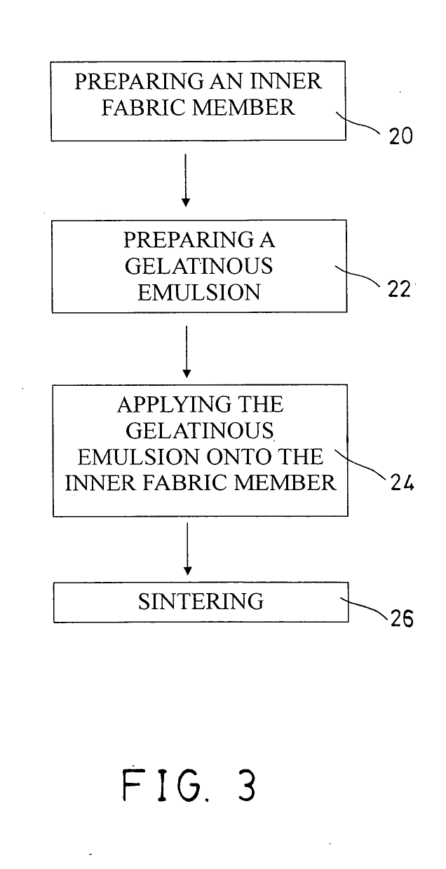

In making or manufacturing the basic board member 1, as shown in FIG. 3, the inner fabric member 10 is first made or prepared in a process 20, and then a gelatinous emulsion is required to be made or prepared in a process 22. The gelatinous emulsion will then be applied onto the outer peripheral portion of the inner fabric member 10 (FIGS. 1, 2, 5), in a process 24 (FIG. 3), in order to form a laminated gel outer layer 30 on the inner fabric member 10 after the gelatinous emulsion is cured.

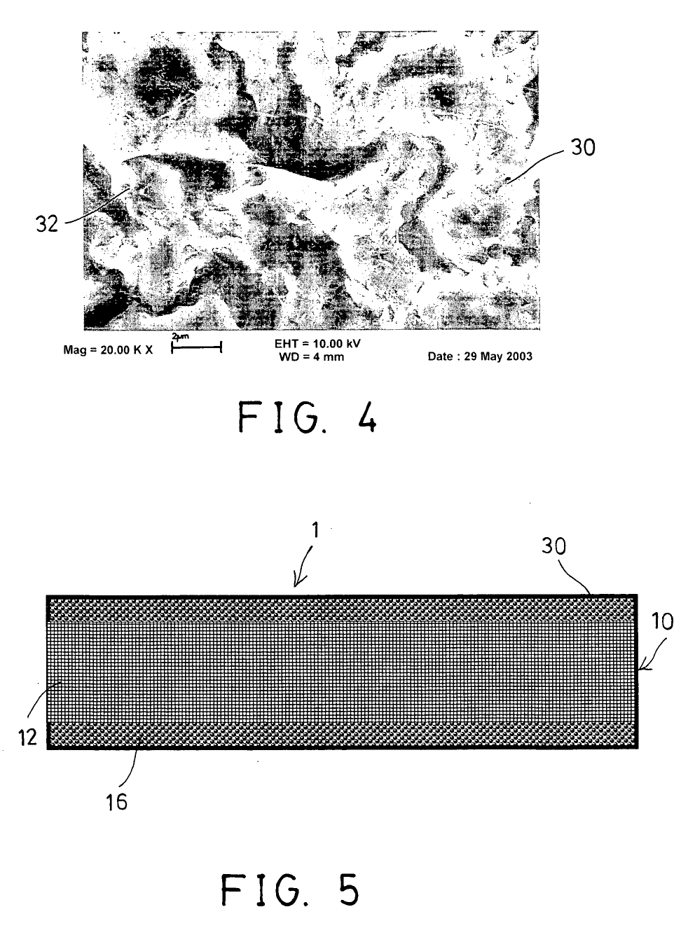

The gelatinous emulsion is made of or includes primarily the polytetrafluoroethylene emulsion and a coupling agent, which are mixed together and stirred with a stirring member or machine (not shown), in a stirring or rotational speed ranging from 2000 to 4000 rpm, to form multi-direction cutting areas, or to form a micro-fibrotic structure 32 within the gel outer layer 30, best shown in FIG. 4.

While preparing or manufacturing the gelatinous emulsion, a porcelain nano powder or nano ceramic powder and/or a SiO₂ powder may further be provided and mixed into the polytetrafluoroethylene emulsion and the coupling agent, in order to increase or to facilitate the low dielectric characteristic of the gelatinous emulsion and/or of the basic board member 1, and thus to increase or to facilitate the electric transmitting effect for the basic board member 1.

After the gelatinous emulsion has been applied onto the outer peripheral portion of the inner fabric member 10 and has been cured, to form the laminated gel outer layer 30 on the inner fabric member 10, the inner fabric member 10 and the laminated gel outer layer 30 are then disposed in such as an oven or furnace (not shown), for being subjected with a high temperature sintering process 26, in order to form the basic board member 1 that includes a low dielectric constant or a low dielectric effect, and that may be used in various electric facilities, for preventing or for avoiding electric leakage, and for facilitating electric transmitting effect of the electric facilities.

For example, the inner fabric member 10 and the laminated gel outer layer 30 may first be heated to a temperature ranging from 150 to 180° C. for about 30˜80 minutes, and may then be heated or sintered with a temperature ranging from 190 to 350° C. for about 120˜160 minutes, in order to form the basic board member 1 that may prevent or avoid electric leakage problem, and that may have an excellent electric transmitting effect.

Accordingly, the basic board member in accordance with the present invention is provided for being used in various electric facilities, and includes a low dielectric constant or a low dielectric effect, for preventing or for avoiding electric leakage, and for facilitating electric transmitting effect.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A basic board member comprising:
an inner fabric member, and
a gelatinous emulsion disposed on said inner fabric member, to form a gel outer layer on said inner fabric member, after said gelatinous emulsion is cured, to facilitate a low dielectric characteristic to said basic board member.

2. The basic board member as claimed in claim 1, wherein said inner fabric member includes at least one fabric layer made of polytetrafluoroethylene (PTFE) material.

3. The basic board member as claimed in claim 2, wherein said inner fabric member includes at least one second fabric layer made of polytetrafluoroethylene (PTFE) material, and engaged onto said at least one fabric layer.

4. The basic board member as claimed in claim 3, wherein said at least one second fabric layer and said at least one fabric layer are inclined relative to each other.

5. The basic board member as claimed in claim 4, wherein said at least one second fabric layer and said at least one fabric layer include an included angle of forty five (45) degrees therebetween.

6. The basic board member as claimed in claim 2 further comprising an outer fabric layer attached onto an outer peripheral portion of said at least one fabric layer of said inner fabric member.

7. The basic board member as claimed in claim 1, wherein said gelatinous emulsion includes a polytetrafluoroethylene emulsion and a coupling agent mixed and stirred together.

8. The basic board member as claimed in claim 7, wherein said gelatinous emulsion further includes a nano ceramic powder mixed therein.

9. The basic board member as claimed in claim 7, wherein said gelatinous emulsion further includes an SiO₂ powder mixed therein.
